(19) United States
(12) Patent Application Publication
(10) Pub. No.: US 2007/0250557 A1
(43) Pub. Date: Oct. 25, 2007

(54) METHOD AND CIRCUIT FOR PERFORMING CORDIC BASED LOEFFLER DISCRETE COSINE TRANSFORMATION (DCT) FOR SIGNAL PROCESSING

(75) Inventors: Jorgen Gotze, Dortmund (DE); Benjamin Heyne, Dortmund (DE); Shang-Jang Ruan, Taipei City (TW); Chi-Cha Sun, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: National Taiwan University of Science and Technology, Taipei City (TW); Universitat Dortmund, Dortmund (DE)

(21) Appl. No.: 11/739,669

(22) Filed: Apr. 24, 2007

(30) Foreign Application Priority Data
Apr. 24, 2006 (EP) EP06008407.6

(51) Int. Cl. G06F 17/14

(52) U.S. Cl. 708/400

(57) ABSTRACT

A low-power and high-quality DCT transformation based on the Cordic method is presented. The proposed Cordic based Loeffler DCT architecture only requires 38 add and 16 shift operations to carry out the DCT transformation. The complexity is almost the same as the complexity of the binDCT-C5. The simulation results show that the DCT according to the invention reduces the area and the power dissipation of the implementation compared to the original Loeffler DCT significantly. Furthermore, it only has a fraction of the power dissipation of the binDCT-C5. The major contribution of the DCT according to the invention is that it not only reduces the area and power consumption significantly, but also keeps the good transformation quality of the original Loeffler DCT. It is worth noticing that the Cordic based Loeffler DCT according to the invention is very suitable for low-power and high-quality CODECs in multimedia hand-held systems.

### CROSS-REFERENCE TO RELATED APPLICATION

This application claims the priority benefit of EP application serial no. EP06008407.6, filed on Apr. 24, 2006. All disclosure of the EP application is incorporated herein by reference.

### BACKGROUND OF THE INVENTION

1. Field of the Invention

The present invention relates to a method and a circuit for performing a Loeffler Discrete Cosine Transformation (DCT) for Signal Processing, and more particularly, to a method and a circuit for performing a Loeffler Discrete Cosine Transformation (DCT) that can be implemented with a minimum number of shift and add operations without loss of quality.

2. Description of Related Art

Recently, many kinds of digital image processing and video compression techniques have been proposed, such as JPEG, Digital Watermark, MPEG and H.263 [1]-[3]. All of the aforementioned standards require Discrete Cosine Transformations (DCT) [1] to aid image/video compression. Therefore, the DCT has become more and more important in today's image/video processing designs. The usage of the DCT is very suitable for low-power and high-quality CODECs in multimedia hand-held systems, but can also be relevant in every data processing methods, in which data have to be reduced or optimized. Therefore the usage of methods for performing the DCT is very wide spreaded in information technology and related technical equipment.

In the past few years, much research has been done on low power DCT designs [4]-[11]. In consideration of VLSI-implementation, the Flow-Graph Algorithm (FGA) is the most popular way to realize the fast DCT (FDCT) [12], [13]. In 1989, Loeffler et al. [14] proposed a low-complexity FDCT/IDCT algorithm based on FGA that requires only 11 multiply and 29 add operations. However, the multiplications consume about 40% of the power and almost account for 45% of the total area [15]. Thus, Tran [16]-[18] proposed the binDCT which approximates multiplications with add and shift operations. Later, an efficient VLSI architecture and implementation of the binDCT was presented in [19]. Although the binDCT reduces the computational complexity significantly, it suffers from losing about 2 dB in PSNR (Peak Signal to Noise Ratio) compared to the Loeffler DCT [15].

COordinate Rotation DIgital Computer (Cordic) is an algorithm which is used to evaluate many functions and applications in signal processing [20], [21]. In addition, the Cordic algorithm is highly suited for VLSI-implementation. Therefore, Jeong et al. [9] proposed a Cordic based implementation of the DCT which only requires 104 add and 84 shift operations to realize a multiplierless transformation yielding the same transformation quality as the Loeffler DCT. Yu and Swartzlander [22] presented a scaled DCT architecture based on the Cordic algorithm which requires two multiply and 32 add operations. However, this DCT architecture needs additional three Cordic rotations at the end of the flow graph to perform the multiplierless transformation. Therefore, both the Cordic based DCT and the scaled Cordic based DCT need more operations than the binDCT [17] does to carry out an exact transformation.

The DCT Background

The two dimensional DCT transforms an 8×8 block sample from spatial domain ƒ(x,y) into frequency domain F(k,l) as follows:

$$\begin{matrix}F ( k , l ) = \frac{1}{4} C ( k ) C ( l ) x \\ = 07 \sum y \\ = 07 \sum f ( x , y ) \cdot cos [ \frac{( 2 x + 1 ) k π}{16} ] cos [ \frac{( 2 y + 1 ) l π}{16} ]\end{matrix} \\ C ( m ) = \{ \begin{matrix}\frac{1}{\sqrt{2}} & if m = 0 \\ 1 & otherwise .\end{matrix} \qquad ( 1 )$$

Since computing the above 2-D DCT by using matrix multiplication requires 8⁴ multiplications, a commonly used approach to reduce the computational complexity is row-column decomposition. The decomposition performs row-wise one-dimensional (1-D) transform followed by a column-wise 1-D transform with an intermediate transposition. An 8-point 1-D DCT can be expressed as follows:

$$F ( k ) = \frac{1}{2} C ( k ) {\sum }_{x = 0}^{7} f ( x ) cos [ \frac{( 2 x + 1 ) k π}{16} ] \\ C ( k ) = \begin{matrix}\frac{1}{\sqrt{2}} & if k = 0\end{matrix} \\ C ( k ) = \begin{matrix}1 & otherwise\end{matrix} \qquad ( 2 )$$

This decomposition approach has two advantages. First, the number of operations is significantly reduced. Second, the original 1-D DCT can be easily replaced by different DCT algorithms efficiently.

MAC Based Loeffler DCT

Many 1-D flow graph algorithms have been reported in the literature [12], [13]. A Loeffler 1-D 8-point DCT algorithm [14] requires 11 multiply and 29 add operations. The flow graph of the Loeffler DCT is illustrated in FIG. 1, in which Cₓ=cos (x) and Sₓ=sin (x). One of its variations has been adopted by the Independent JPEG Group [24] to implement the popular JPEG image coding standard. Note that this factorization requires a uniform scaling factor of ½\sqrt{2} at the end of the flow graph to obtain the original DCT coefficients. In the 2-D transform this scaling factor becomes ⅛, and it can be easily implemented by a shift operation. Although the Loeffler DCT requires multipliers, which results in large power dissipation and area overhead, it offers better quality than other approaches. Therefore it is especially useful for high-quality CODECs.

binDCT

Although the Loeffler DCT is very useful for many image/video compressions, it still needs multiplications which are slow in both software and hardware implementations. More importantly, hardware implementations of general multiplications need a lot of area and power. In this regard, Tran [16]-[18] presented a fast bi-orthogonal block transform called binDCT, which can be implemented by using add and shift operations with lifting scheme (i.e., there is no multiplication). The binDCT is a fast multiplierless approximation of the DCT which inherits all lifting properties, such as fast implementations, invertible integer-to-integer mapping, in-place computation and low dynamic range. However, its quality is worse than the Loeffler DCTs.

The flow graph of an 8-point binDCT-C5 is illustrated in FIG. 2. If there is a close look at the structure, it can be easily observed that all multiplications are replaced by hardware-friendly dyadic values (i.e., in the format of k/2^{m}, where k and m are integers), which can be implemented by using shift and add operations. According to FIG. 2, the binDCT-C5 requires 36 add and 17 shift operations to perform the DCT transformation, which makes it very suitable for VLSI-implementations.

It should be noted that the binDCT also requires specified scaling factors at the end of the flow graph to reconstruct the original DCT coefficients. The detailed scaling factor information can be found in [18]. On the other hand, the most commonly used DCT-based CODECs for signal processing are usually followed by a quantizer, where the DCT outputs are scaled by the corresponding scaling constants that are stored in the quantization table. Hence, each scaling factor of the binDCT output can be incorporated into the quantization table without requiring any additional hardware resources. Although binDCT reduces the computational complexity significantly, it also looses the accuracy of the transformation results.

Cordic Based DCT

Besides the binDCT, there is another popular method to implement a fast multiplierless approximation of the DCT. That is using the Cordic algorithm [9], [22], [25]. As the binDCT a DCT based on Cordics can also be realized with shift and add operations [26]. A Cordic has a very regular structure and hence, is very suitable for VLSI design. FIG. 3 shows the flow graph of the 8-point Cordic based DCT with six Cordic Rotations [9] which requires 104 add and 84 shift operations.

In order to realize a vector rotation which rotates a vector (x, y) by an angle θ, the circular rotation angle is described as
θ=iΣσᵢ·tan⁻¹ (2⁻ⁱ)
with σᵢ=±1. (3)

Then, the vector rotation can be performed iteratively [9], [26] as follows:
xᵢ₊₁=xᵢ−σᵢ·yᵢ·2⁻ⁱ
yᵢ₊₁=yᵢ+σᵢ·xᵢ·2⁻ⁱ. (4)

In Eq. (4), only shift and add operations are required to perform the operation. Furthermore the results of the rotation iterations need to be compensated (scaled) by a compensation factor s. This can be done by using the following iterative approach:
xᵢ₊₁=xᵢ(1+γᵢ·Fᵢ)
yᵢ₊₁=yᵢ(1+γᵢ·Fᵢ)
with iΠ(1+γᵢ·Fᵢ)≅s
and γᵢ=(0,1,−1),Fᵢ=2⁻ⁱ. (5)

Equations (4) and (5) describe the Cordic rotation. Implementing the circular rotations of the DCT by Cordic rotations yields the Cordic based DCT as shown in FIG. 3. When using Cordics to replace the multiplications of the 8-point DCT whose rotation angles θ are fixed, some unnecessary Cordic iterations may be skipped without losing accuracy. Table I shows the used rotation and compensation iterations for Jeong's Cordic based algorithm [9], using the standard DCT flow graph as a basis. Although the Cordic based DCT reduces the number of computations, it still needs more operations than the binDCT [17].

TABLE I
Cordic parameters for [9]

| | | | | |
|---|---|---|---|---|
| Cordic | (1) | (2) | (3,6) | (4,5) |
| Angle | $\frac{π}{4}$ | $\frac{3 π}{8}$ | $\frac{7 π}{16}$ | $\frac{3 π}{16}$ |

Rotation iterations [σᵢ, i] according to Eq. (4)

| | | | | |
|---|---|---|---|---|
| 1 | −1, 0 | −1, 2 | +1, 0 | −1, 1 |
| 2 | — | −1, 3 | +1, 1 | −1, 3 |
| 3 | — | −1, 6 | +1, 3 | −1, 10 |
| 4 | — | −1, 7 | +1, 10 | −1, 14 |

Compensation iterations [1 + γᵢ ·Fᵢ] according to Eq. (5)

| | | | | |
|---|---|---|---|---|
| 1 | $1 - \frac{1}{4}$ | $1 + \frac{1}{32}$ | $\frac{1}{2} + \frac{1}{8}$ | $1 - \frac{1}{8}$ |
| 2 | $1 - \frac{1}{16}$ | $1 + \frac{1}{128}$ | $1 + \frac{1}{256}$ | $1 + \frac{1}{64}$ |
| 3 | $1 + \frac{1}{256}$ | $1 + \frac{1}{1024}$ | $1 + \frac{1}{4096}$ | $1 + \frac{1}{1024}$ |
| 4 | $1 + \frac{1}{512}$ | $1 + \frac{1}{4096}$ | — | $1 + \frac{1}{4096}$ |
| 5 | $1 + \frac{1}{4096}$ | — | — | — |

### BRIEF DESCRIPTION OF THE DRAWINGS

The accompanying drawings are included to provide a further understanding of the invention, and are incorporated in and constitute a part of this specification. The drawings illustrate an embodiment of the invention and, together with the description, serve to explain the principles of the invention.

FIG. 1 illustrates a graph of an 8-point Loeffler DCT.

FIG. 2 illustrates a graph of an 8-point binDCT-C5 architecture [18].

FIG. 3 illustrates a graph of an 8-point Cordic based DCT [9].

FIG. 4 illustrates a butterfly of a Cordic rotation.

FIG. 5 illustrates a graph of an 8-point pure Cordic based Loeffler DCT according to an embodiment of the present invention,

FIG. 6 illustrates a view of an unfolded structure of a

$$\frac{3 π}{8}$$

angle according to an embodiment of the present invention.

FIG. 7 illustrates a view of an unfolded structure of a

$$\frac{π}{16}$$

angle according to an embodiment of the present invention.

FIG. 8 illustrates a view of an unfolded structure of a

$$\frac{3 π}{16}$$

angle according to an embodiment of the present invention,

FIG. 9 illustrates a graph of an 8-point Cordic based Loeffler DCT architecture according to an embodiment of the present invention.

FIG. 10 illustrates experimental results of the Power and PDP.

FIG. 11 illustrates experimental results of the EDP and EDDP.

FIG. 12 illustrates average PSNR from high to low compression quality in JPEG-6b.

FIG. 13 illustrates average PSNR from high to low compression quality in XVID.

FIG. 14 illustrates PSNR of the 300-frame QCIF of the test video sequence “Foreman” using a quantization method.

### DETAIL DESCRIPTION OF THE INVENTION

Accordingly, the present invention provides a method and a circuit for obtaining a high quality DCT, wherein the method can be implemented with a minimum number of shift and add operations without loss of quality.

The present invention provides a method for performing a DCT using a coordinate rotation digital computer method (Cordic method), wherein all relationships and butterfly stages for carrying out the Loeffler DCT are solely expressed as Cordic transformations and the Cordic transformations are carried out by a combination of shift and add operations with compensational steps in a final quantizer without multiplication operations.

The present invention also provides a circuit for the method for performing a DCT using a coordinate rotation digital computer method (Cordic method) described above.

Based on the information and the accompanying figures disclosed in the present invention, those skilled in the art would understand the advantages and would be able to practice the present invention.

The present invention proposes a computationally efficient and high-quality Cordic based Loeffler DCT architecture, which is optimized by taking advantage of certain properties of the Cordic algorithm and its implementations. Based on the special properties of the Cordic algorithm, the Cordic based Loeffler DCT is optimized by ignoring some unnoticeable iterations and shifting the compensation steps of each angle to the quantizer. The computational complexity is reduced from 11 multiply and 29 add operations (Loeffler DCT) to 38 add and 16 shift operations (which is almost the same complexity as for the binDCT). Moreover, the experimental results show that the presented Cordic based Loeffler DCT architecture only occupies 19% area and consumes about 16% power of the original Loeffler DCT. Furthermore, it reduces the power dissipation to about 42% of that of the binDCT. On the other hand, it also retains the good transformation quality of the Loeffler DCT in PSNR simulation results.

According to an embodiment of the present invention, all relationships and butterfly stages for carrying out the Loeffler DCT are solely expressed as Cordic transformations and the Cordic transformations are carried out by a combination of shift and add operations with compensational steps in a common final quantizer without multiply operations. Therefore the description of the steps of the method becomes very uniform and certain properties of the Cordic algorithm and the Cordic based Loeffler DCT can be used for an optimization of the respective method by means of the number of shift and add operations. The compensation steps can be predominantly carried out in a final quantizer which works fast and needs no additional hardware when it is built as a quantization table.

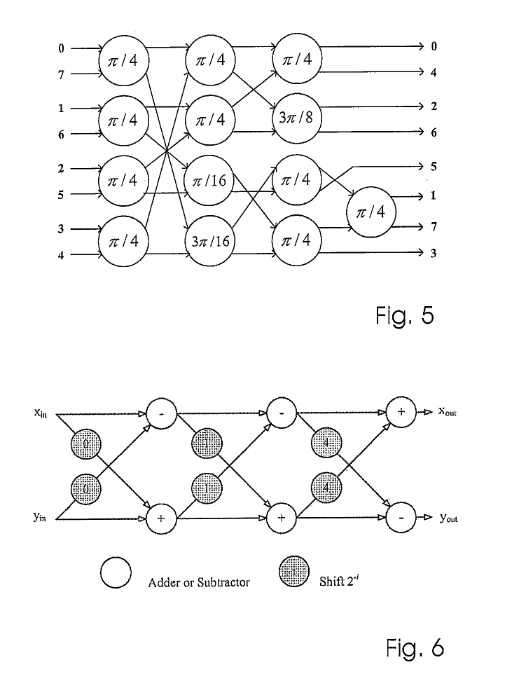

The corresponding relationship between various transformations and their sequence for carrying out the method are illustrated in accompanying FIGS. 5-9 and in tables I and II below.

Cordic Based Loeffler DCT

Based on works about Cordic based signal transforms [27]-[29], an optimized Cordic based Loeffler DCT is proposed. This implementation only requires 38 add and 16 shift operations to perform a multiplierless DCT transformation. The original Loeffler DCT was taken as the starting point for the optimization, because the theoretical lower bound of the number of multiplications required for the 1-D 8-point DCT had been proven to be 11 [30].

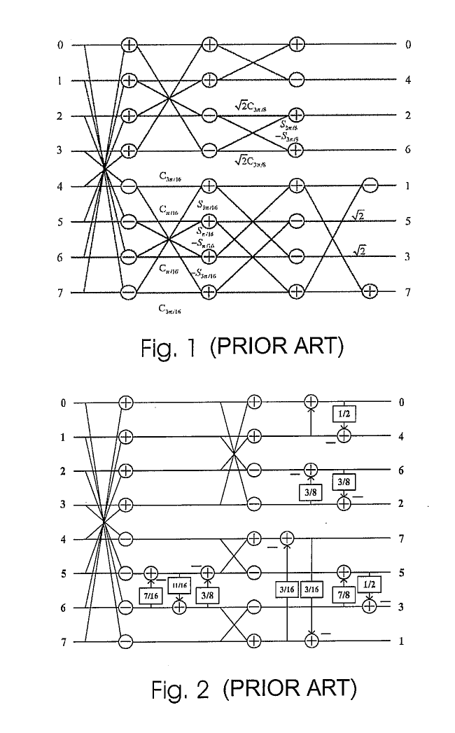

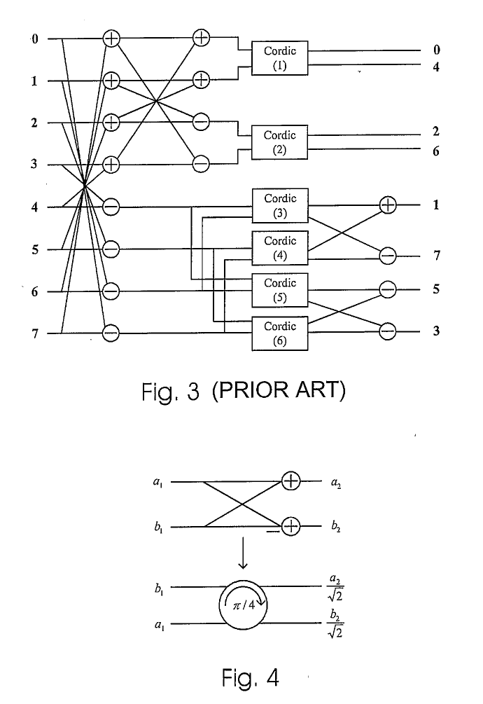

In order to derive the proposed method, first, the butterfly at the beginning of Loeffler's flow graph as shown in FIG. 1 are considered. In this case, the butterfly can be expressed as:

$$[ \begin{matrix}{a}_{2} \\ {b}_{2}\end{matrix} ] = [ \begin{matrix}1 & 1 \\ - 1 & 1\end{matrix} ] \cdot [ \begin{matrix}{b}_{1} \\ {a}_{1}\end{matrix} ] , \qquad ( 6 )$$

and the matrix can then be decomposed to

$$[ \begin{matrix}1 & 1 \\ - 1 & 1\end{matrix} ] = \sqrt{2} \cdot [ \begin{matrix}\frac{1}{\sqrt{2}} & \frac{1}{\sqrt{2}} \\ - \frac{1}{\sqrt{2}} & \frac{1}{\sqrt{2}}\end{matrix} ] . \qquad ( 7 )$$

This equals a Cordic rotating the input values by π/4, followed by a scaling of \sqrt{2} as shown in FIG. 4.

The scaled butterflies can also be replaced by Cordics using θ=3π/8, π/16 and 3π/16 respectively. Hence, all butterflies of the Loeffler DCT shown in FIG. 1 can be replaced to derive a pure Cordic based Loeffler DCT as shown in FIG. 5.

As described above, the most commonly used DCT-based CODECs for signal processing are usually followed by a quantizer. In this regard some Cordic iterations can be skipped without losing visual quality and the compensation steps can be shifted to the quantization table without using additional hardware. Next, the optimization of each rotation angle is carried out to reduce the computational complexity.

First, due to the special characteristic of the Loeffler DCT, the five needed compensation iterations of the π/4 rotation (see Table I) can be shifted to the end of the flow graph. Hence, the π/4 rotation only needs to perform two add operations.

Second, for the angle θ=3π/8, the number of rotation iterations can be reduced to three and also all compensation steps are shifted to the quantizer. Although the optimized 3π/8 rotation will decrease the quality of the results, the influences are not noticeable in video sequence streams or image compression. According to the dependence flow graph of the unfolded Cordic architecture presented in [31], a three stage unfolded Cordic for the angle θ=3π/8 is implemented as shown in FIG. 6. Note that the white circle in FIG. 6 means an Adder or a Subtractor, and the shadowed circle means a shifter. As illustrated, it needs six add and six shift operations to approximate the 3π/8 rotation.

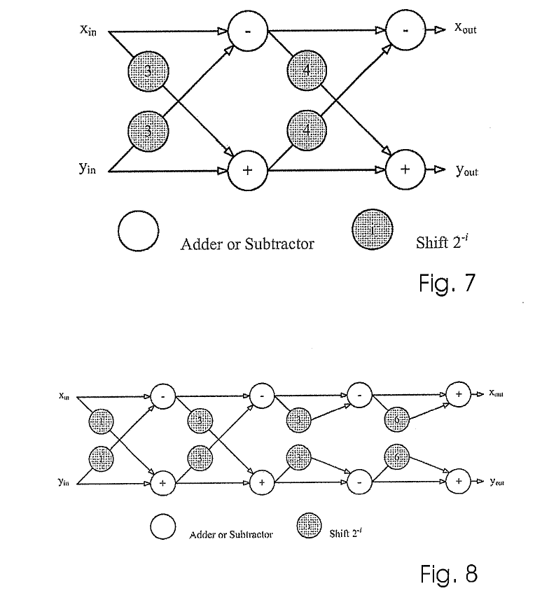

Third, when we take a closer look at the angle θ=π/16, it can be easily observed that the needed compensation of the π/16 rotation is very close to one. Thus, the compensation iterations of the π/16 rotation can be ignored. Therefore, it only needs two iterations in the rotation calculation as shown in FIG. 7.

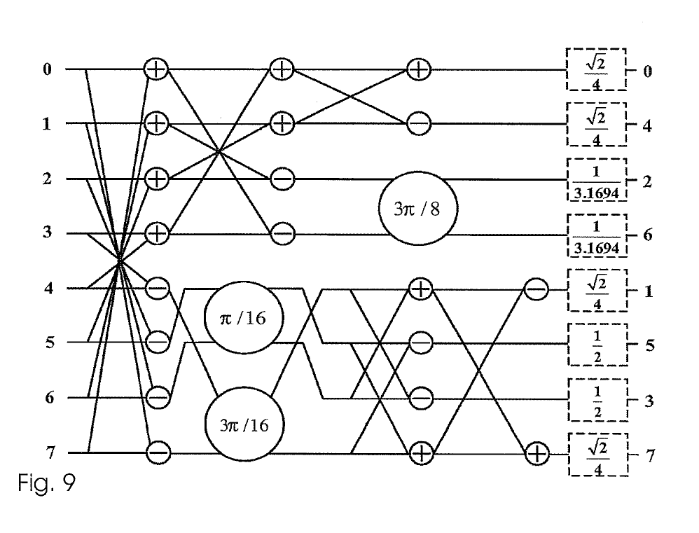

Unfortunately, any compensation iterations of the 3π/16 rotation can not be shifted to the end of the graph. This is due to the data correlation between the subsequent stages of the π/16 and 3π/16 rotations. However, some unnoticeable rotation and compensation iterations can be ignored to reduce the computational complexity of the angle θ=3π/16. The optimized unfolded flow graph as shown in FIG. 8 is a little more complex than that of the other angles. To obtain the Register Transfer Level (RTL) description of the optimized DCT, these flow graphs are used to replace the Cordics shown in FIG. 9.

TABLE II
Cordic based Loeffler DCT-Cordic parameters

| | | | | |
|---|---|---|---|---|
| Cordic | (1) | (2) | (3) | (4) |
| Angle | $\frac{π}{4}$ | $\frac{3 π}{8}$ | $\frac{π}{16}$ | $\frac{3 π}{16}$ |

Rotation iterations [σᵢ, i] according to Eq. (4)

| | | | | |
|---|---|---|---|---|
| 1 | −1, 0 | −1, 0 | −1, 3 | −1, 1 |
| 2 | — | −1, 1 | −1, 4 | −1, 3 |
| 3 | — | +1, 4 | — | — |

Compensation iterations [1 + γᵢ · Fᵢ] according to Eq. (5)

| | | | | |
|---|---|---|---|---|
| 1 | — | — | — | $1 - \frac{1}{8}$ |
| 2 | — | — | — | $1 + \frac{1}{64}$ |

Hence, it only requires 38 add and 16 shift operations to realize the DCT transformation for the proposed Cordic based Loeffler DCT. FIG. 9 shows the optimized flow graph, including the scaling factors incorporated into the quantization table. Table II summarizes the Cordic rotation and compensation iterations of the proposed Cordic based Loeffler DCT.

Table III summarizes the number of operations of the different DCT architectures. The proposed DCT according to the invention has the same low computational complexity as the binDCT. But, as subsequently shown, it achieves the same high transformation quality as that of the Loeffler DCT.

TABLE III
Complexity of different DCT architectures

| DCT typeOperation | Multiply | Add | Shift |
|---|---|---|---|
| Loeffler DCT | 11 | 29 | 0 |
| Cordic based DCT [9] | 0 | 104 | 82 |
| Cordic based Loeffler DCT | 0 | 38 | 16 |
| according to the invention | | | |
| binDCT-C5 | 0 | 36 | 17 |

Experiment Environment

In the experiments, different criteria were used to evaluate four architectures: Loeffler DCT, Cordic based DCT, binDCT-C5 and Cordic based Loeffler DCT. The word-length of all implementations is 12 bits. After synthesizing with TSMC 0.13-μm technology library, Synopsys PrimePower was used to estimate the power consumption at gate-level. Then these DCT architectures were implemented in the JPEG and XVID CODECs to compare and analyze the quality of the compression results.

Simulation Results

In order to analyze the performance of the proposed Cordic based Loeffler DCT, the four different DCT architectures were modeled as RTL (i.e. Verilog). It should be noted that constant multipliers were used to model the Loeffler DCT's RTL. After synthesizing with Synopsys Design Compiler using the 0.13-μm TSMC/Artisan Design Kit library at 1.2 v, Synopsys PrimePower was used to estimate the power consumption at gate-level without the interconnections. No tools or further techniques were used to optimize these DCT architectures, such as Synopsys Power Compiler or pipeline stages.

TABLE IV
TSMC 0.13-μm at 1.2 V without pipeline

| Architecture | Loeffler | Cordic | Cordic base | binDCT- |
|---|---|---|---|---|
| Measures | DCT | based DCT | Loeffler DCT | C5 |
| Power (mW) | 3.557 | 1.954 | 0.5616 | 0.9604 |
| Area (GateCount) | 15.06 K | 6.66 K | 2.81 K | 2.83 K |
| Delay (ns) | 13.49 | 15.08 | 8.37 | 12.17 |

The power consumptions, areas, and time delays are shown in Table IV. Some important points may be easily observed. First, the DCT architecture according to the invention only consumes 19% of the area and about 16% of the power of the original Loeffler DCT. Secondly, the DCT architecture according to the invention occupies the same area as the binDCT-C5. However, it has only about 59% of the power dissipation and half the delay time of the binDCT-C5. Finally, it is worth noting that the DCT architecture according to the present invention not only reduces the computational complexity significantly, but also achieves the best performance in all criteria.

To further illustrate the low-power features of the proposed method, the Power, Power-Delay Product (PDP), Energy-Delay Product (EDP) and Energy-Delay-Delay Product (EDDP) were analyzed as shown in Table V. The delay is the execution time of the DCT method, and the PDP is the average energy consumed per DCT transformation. A lower PDP means that the power consumption is better translated into speed of each operation and the EDP represents that one can trade increased delay for lower energy of each operation. Finally, the EDDP represents whether or not it results in a voltage-invariant efficiency metric.

TABLE V
Power, Power-Delay Product (PDP), Energy-Delay Product (EDP) and
Energy-Delay-Delay Product (EDDP)

| | | Cordic | | |
|---|---|---|---|---|
| Architecture | | based | Cordic based | binDCT- |
| Measures | Loeffler DCT | DCT | Loeffler DCT | C5 |
| Power | 3.557 | 1.954 | 0.5616 | 0.9604 |
| Power-delay | 47.99 | 29.47 | 4.7 | 11.69 |
| Product | | | | |
| Energy-delay | 647.39 | 444.41 | 39.34 | 142.27 |
| Product | | | | |
| Energy-Product | 8733.22 | 6701.67 | 329.27 | 1731.34 |

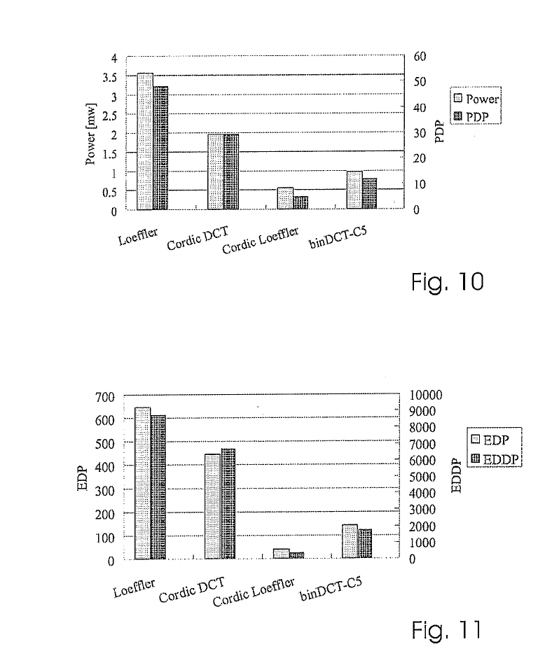

FIG. 10 illustrates the experimental results of the power consumption and the PDP. As illustrated for the PDP the proposed DCT method only consumes about 10% of the PDP of the Loeffler DCT and 16% of the PDP of the Cordic based DCT respectively. It also reduces the PDP by about 59% compared to the binDCT-C5. FIG. 11 shows the EDP and the EDDP. As shown, the performance of the proposed DCT method is far superior to the other DCT methods, especially in the EDDP.

In summary, the Cordic based Loeffler DCT method according to the present invention not only reduces power consumption significantly, but also achieves the best results in area and delay time compared to the other methods. Therefore, the DCT method according to the present invention is suitable to be applied in low-power and high performance devices.

Next, these DCT architectures will be embedded into JPEG and XVID CODECs respectively to evaluate the quality of each DCT method.

Performance of Cordic based Loeffler DCT in JPEG

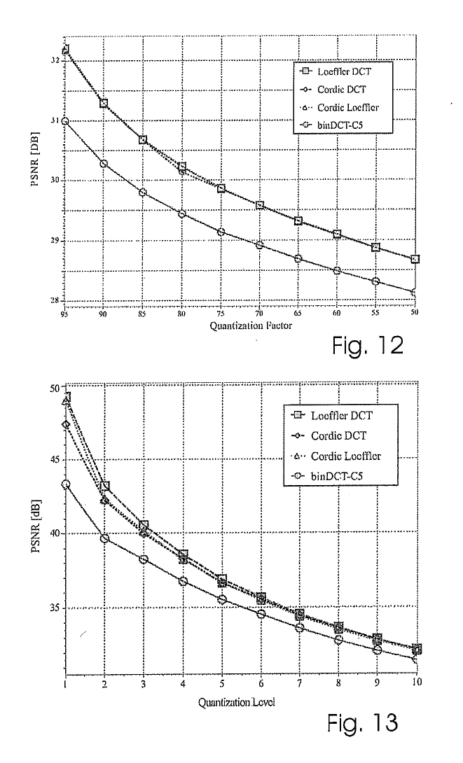

In order to demonstrate the high-quality feature of the DCT method according to the present invention, the method has been implemented according to the framework of the JPEG standard based on the open source code from the Independent JPEG Group [24]. It should be noted that the JPEG quantization matrix was modified to incorporate the 2-D scaling factors to obtain the original DCT coefficients. FIG. 12 demonstrates the comparison of the average PSNR of the four DCT methods from high to low quality compression (i.e., quantization factors from 95 to 50—An increasing quantization factor results in better quality) using some well-known test images.

It can be easily observed from FIG. 12 that the performance of the DCT method according to the present invention is very close to that of the Loeffler DCT. Therefore, the quality of the method according to the present invention is also much better than that of the binDCT-C5. For example, when the quality factor is 95, the result obtained by the DCT method according to the present invention is about 1 dB higher than that of the binDCT-C5. Table VI lists the PSNRs of each DCT method from high to low quality factors for three different test images. The “Factors” column shows the quality factor from 95 to 50 for each DCT method. In the “Average” row, the average quality of the three images from 95 to 50 factors for each DCT method is shown.

TABLE VI
The PSNR for quality factors 50 to 95 in JPEG-6B

| | DCT | | | | | | | | | | | |
|---|---|---|---|---|---|---|---|---|---|---|---|---|
| | Loeffer DCT | | | Cordic DCT | | | Cordic Loeffer | | | binDCT-C5 | | |
| | Lena | Baboon | Peppers | Lena | Baboon | Peppers | Lena | Baboon | Peppers | Lena | Baboon | Peppers |
| 95 | 35.71 | 28.85 | 32.07 | 35.67 | 28.83 | 32.06 | 35.68 | 28.83 | 32.06 | 33.84 | 28.31 | 30.84 |
| 90 | 34.61 | 27.95 | 31.33 | 34.58 | 27.94 | 31.32 | 34.58 | 27.94 | 31.32 | 33.1 | 27.51 | 30.24 |
| 85 | 33.96 | 27.2 | 30.87 | 33.95 | 27.2 | 30.87 | 33.95 | 27.2 | 30.87 | 32.66 | 26.84 | 29.9 |
| 80 | 33.48 | 26.66 | 30.54 | 33.47 | 26.65 | 30.28 | 33.47 | 26.65 | 30.53 | 32.33 | 26.34 | 29.66 |
| 75 | 33.09 | 26.21 | 30.29 | 33.08 | 26.2 | 30.28 | 33.08 | 26.2 | 30.28 | 32.05 | 25.92 | 29.43 |
| 70 | 32.81 | 25.86 | 30.07 | 32.79 | 25.86 | 30.07 | 32.8 | 25.86 | 30.07 | 31.86 | 25.61 | 29.27 |
| 65 | 32.54 | 25.54 | 29.86 | 32.53 | 25.54 | 29.85 | 32.54 | 25.54 | 29.85 | 31.66 | 25.32 | 29.08 |
| 60 | 32.32 | 25.29 | 29.67 | 32.3 | 25.28 | 29.67 | 32.31 | 25.28 | 29.66 | 31.48 | 25.07 | 28.9 |
| 55 | 32.12 | 25.05 | 29.44 | 32.12 | 25.05 | 29.44 | 32.12 | 25.05 | 29.44 | 31.32 | 24.85 | 28.74 |
| 50 | 31.92 | 24.85 | 29.25 | 31.92 | 24.84 | 29.24 | 31.92 | 24.84 | 29.24 | 31.14 | 24.66 | 28.55 |
| Average | 33.26 | 26.35 | 30.34 | 33.24 | 26.34 | 30.31 | 33.25 | 26.34 | 30.33 | 32.14 | 26.04 | 29.46 |

Both FIG. 12 and Table VI imply that the Cordic based Loeffler DCT method according to the invention has better quality than the binDCT-C5 for the JPEG standard.

Performance of the Cordic based Loeffler DCT in XVID

The DCT method of the present invention was also tested with the video coding standard MPEG-4 by using a XVID CODEC software [32]. The default DCT method in the CODEC of the selected XVID implementation is based on Loeffler's factorization using floating-point multiplications. In this part, each DCT method was implemented into the XVID software, and simulated with some well-known video sequences to show the performance of the method according to the invention. Table VII lists all PSNR values of the different DCT methods from high to low quality compression (i.e., quantization steps from 1 to 10—A larger quantization step results in worse quality) for three CIF video sequences. Moreover, FIG. 13 illustrates the average PSNRs from table VII to show the high-quality feature of the DCT method according to the invention.

TABLE VII
The average PSNR for quantization steps 1 to 10 in XVID

| | DCT | | | | | | | | | | | |
|---|---|---|---|---|---|---|---|---|---|---|---|---|
| | Loeffer DCT | | | Cordic DCT | | | Cordic Loeffer | | | binDCT-C5 | | |
| Sequence | Mobile | Foreman | Paris | Mobile | Foreman | Paris | Mobile | Foreman | Paris | Mobile | Foreman | Paris |
| 1 | 49.44 | 49.26 | 49.09 | 46.64 | 48.29 | 47.29 | 49.54 | 48.92 | 48.64 | 43.45 | 41.51 | 45.12 |
| 2 | 42.8 | 43.33 | 43.49 | 41.54 | 42.64 | 42.48 | 41.72 | 42.56 | 42.69 | 39.21 | 39.09 | 40.75 |
| 3 | 40.13 | 40.76 | 40.77 | 39.38 | 40.42 | 40.12 | 39.61 | 40.4 | 40.44 | 37.87 | 37.86 | 39.06 |
| 4 | 37.89 | 39.07 | 38.81 | 37.55 | 38.89 | 38.42 | 37.47 | 38.78 | 38.46 | 36.22 | 36.72 | 37.31 |
| 5 | 35.83 | 37.72 | 37.07 | 35.59 | 37.6 | 36.75 | 35.55 | 37.53 | 36.85 | 34.65 | 35.84 | 36.02 |
| 6 | 34.47 | 36.7 | 35.81 | 34.37 | 36.64 | 35.61 | 34.23 | 36.55 | 35.6 | 33.54 | 35.16 | 34.88 |
| 7 | 33.1 | 35.86 | 34.62 | 33.03 | 35.83 | 34.44 | 32.92 | 35.75 | 34.47 | 32.36 | 34.51 | 33.91 |
| 8 | 32.08 | 35.16 | 33.71 | 32.09 | 35.15 | 33.61 | 31.92 | 35.06 | 33.58 | 31.45 | 33.85 | 33 |
| 9 | 31.11 | 34.55 | 32.86 | 31.13 | 34.57 | 32.75 | 30.99 | 34.48 | 32.75 | 30.57 | 33.41 | 32.26 |
| 10 | 30.36 | 34 | 32.15 | 30.41 | 34.03 | 32.1 | 30.25 | 33.93 | 32.05 | 29.87 | 32.96 | 31.57 |
| Average | 36.72 | 38.64 | 37.84 | 36.17 | 38.4 | 37.36 | 36.42 | 38.4 | 37.55 | 34.92 | 36.09 | 36.39 |

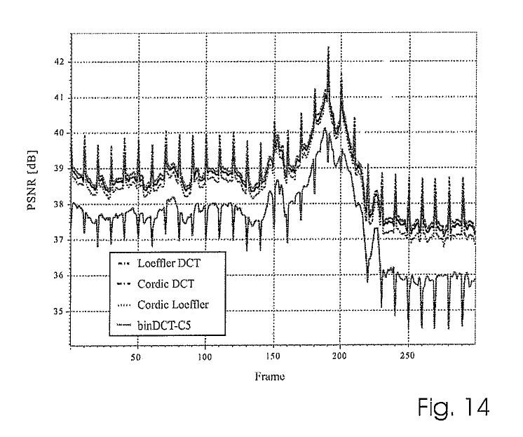

As can be seen from the PSNR simulation results, the method according to the present invention performs as well as the Loeffler DCT in terms of video quality. For instance, when the quantization step is 4, the PSNR of the DCT method according to the invention is about 1.5 dB higher than that of the binDCT-C5. Also, the average PSNR is about 2 dB higher than that of the binDCT-C5. As shown in FIG. 14, a quantization step of 4 is used for the 300-frame CIF of the “Foreman” test video sequence. Obviously the video sequence simulation results of the Cordic based Loeffler DCT method according to the invention are very similar to the Loeffler DCT.

In summary, these XVID based simulation results clearly show that the Cordic based Loeffler DCT method according to the present invention performs favorably compared to the reference implementations in terms of video quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for performing a Loeffler discrete cosine transformation (Loeffler DCT), comprising:
using a coordinate rotation digital computer method (Cordic method) suitable for signal processing, wherein all relationships and butterfly stages are expressed as Cordic transformations, and wherein the Cordic transformations are carried out by a combination of shift and add operations with compensational steps in a final quantizer without multiply operations.

2. The method according to claim 1, wherein all relationships and butterfly stages for carrying out the Loeffler DCT are expressed as Cordic transformations.

3. The method according to claim 1, wherein the Cordic-transformations except for Cordic transformations for π/16, 3π/8, 3π/16 are directly carried out by a combination of shift and add operations each with a compensational step in a final quantizer.

4. The method according to claim 1, wherein the method for performing the Loeffler DCT comprises 38 add and 16 shift operations.

5. The method according to claim 1, wherein the scaled butterflies of the Loeffler DCT are replaced by Cordic transformations using θ=3π/8, θ=π/16, θ=3π/16 and θ=π/4 to derive a pure Cordic based Loeffler DCT.

6. The method according to claim 5, wherein compensation iterations of the π/4 rotation are shifted to the final quantizer.

7. The method according to claim 5, wherein the Cordic transformation of π/4 is carried out with two add operations.

8. The method according to claim 5, wherein the Cordic transformations for π/16 are carried out by a combination of shift and add operations.

9. The method according to claim 5, wherein the Cordic transformations for 3π/8 are carried out by a combination of shift and add operations.

10. The method according to claim 9, wherein the Cordic transformation for 3π/8 is carried out by three rotation iterations and shifting all compensational steps to the final quantizer.

11. The method according to claim 9, wherein the Cordic transformation for 3π/8 is carried out by six add and six shift operations for approximating the 3π/8 Cordic rotation.

12. The method according to claim 5, wherein the Cordic transformation for π/16 is carried out by two rotation iterations while ignoring needed compensation.

13. The method according to claim 5, wherein the Cordic transformation for 3π/16 is carried out by a combination of shift and add operations including two compensational steps.

14. The method according to claim 13, wherein the Cordic transformation for 3π/16 is carried out by four rotation iterations.

15. The method according to claim 1, wherein compensation steps in the final quantizer are carried out using a quantization table.

16. A circuit for carrying out the method according to claim 1, comprising shifting means, adding and subtracting means and a final quantizer.

17. The circuit according to claim 16, wherein the circuit comprises a VLSI design.

18. The circuit according to claim 16, wherein the final quantizer is built using a quantization table.

19. A computer program comprising a computer-readable storage medium including a program suitable for a computer to carry out a method for performing a Loeffler discrete cosine transformation (Loeffler DCT) for signal processing comprising using a coordinate rotation digital computer method (Cordic method) suitable for signal processing, wherein all relationships and butterfly stages are expressed as Cordic transformations, and wherein the Cordic transformations are carried out by a combination of shift and add operations with compensational steps in a final quantizer without multiply operations.

20. A computer-readable storage medium comprising a program suitable for a computer to carry out a method for performing a Loeffler discrete cosine transformation (Loeffler DCT) for signal processing comprising using a coordinate rotation digital computer method (Cordic method) suitable for signal processing, wherein all relationships and butterfly stages are expressed as Cordic transformations, and wherein the Cordic transformations are carried out by a combination of shift and add operations with compensational steps in a final quantizer without multiply operations.
